(19) United States
(12) Patent Application Publication
(10) Pub. No.: US 2012/0240096 A1
(43) Pub. Date: Sep. 20, 2012

(54) OPEN SOURCE MANAGEMENT SYSTEM AND METHOD

(75) Inventor: Rami SASS, Tel-Aviv (IL)

(73) Assignee: WHITE SOURCE LTD., Ariel (IL)

(21) Appl. No.: 13/424,913

(22) Filed: Mar. 20, 2012

Related U.S. Application Data
(60) Provisional application No. 61/454,537, filed on Mar. 20, 2011.

(51) Int. Cl. G06F 9/44

(52) U.S. Cl. 717/101

(57) ABSTRACT

A method of controlling and managing open source software (OSS) resources used by developers in their software projects is provided herein. The method includes the following steps: analyzing the software projects, to yield a proprietary projects model that represents dependencies of source code portions of the software projects upon the OSS resources; generating and updating over time, OSS profiles for the OSS resources exhibiting technical and legal attributes; generating and updating over time, projects profiles for the software projects, based on the model and on monitoring and learning OSS resources usage by the developers; and monitoring actual OSS resources usage and providing the developers with at least one of: reports responsive to the changes the OSS; and guidance responsive to queries from the developers, wherein the reports and the guidance are based on the actual OSS usage, projects model, the projects profiles, and the OSS profiles.

### CROSS-REFERENCE TO RELATED APPLICATIONS

The present application is a non-provisional patent application claiming priority to U.S. provisional patent application No. 61/454,537 filed on Mar. 20, 2011.

### BACKGROUND

1. Technical Field

The present invention relates to open source software development environment and more particularly, to applying configuration management concepts to open source software development.

2. Discussion of the Related Art

As open source software (OSS) becomes more popular with developers, new challenges for managing these collaborative resources arise. One such challenge stems from the legal nature of most open source libraries and restrictions applied to the usage thereof. Another challenge stems from the high amount of potential developers, possibly over a cloud environment, using the same libraries while other developers constantly improve them.

It would be advantageous therefore, to provide a management system for open source resources that provides visibility of use to software developers who use open source resources both in terms of technical updates and dependencies and also in terms of legal restrictions imposed on the open source resources. It would also be advantageous to benefit from the cloud environment by applying crowd sourcing to the open source software resources.

### BRIEF SUMMARY

One aspect of the invention provides a method of controlling and managing open source software (OSS) resources used by developers in their proprietary software projects. The method includes the following steps: analyzing the proprietary software projects, to yield a project model that represents dependencies of source code portions of the software projects upon the OSS resources; generating and updating over time, OSS profiles for the OSS resources exhibiting technical and legal attributes thereof; generating and updating over time, proprietary projects profiles for the software projects, based on the model and on monitoring and learning OSS resources usage by the developers; and monitoring actual OSS resources usage and providing the developers with at least one of: (i) reports responsive to the changes the OSS; and (ii) guidance responsive to queries from the developers, wherein the reports and the guidance are based on the actual OSS usage, the proprietary projects profiles, and the OSS profiles.

Other aspects of the invention may include a system arranged to execute the aforementioned method and a computer readable program configured to execute the aforementioned method. These, additional, and/or other aspects and/or advantages of the embodiments of the present invention are set forth in the detailed description which follows; possibly inferable from the detailed description; and/or learnable by practice of the embodiments of the present invention.

### BRIEF DESCRIPTION OF THE DRAWINGS

For a better understanding of embodiments of the invention and to show how the same may be carried into effect, reference will now be made, purely by way of example, to the accompanying drawings in which like numerals designate corresponding elements or sections throughout.

In the accompanying drawings:

FIG. 1 is a high level schematic block diagram illustrating the system according to some embodiments of the invention;

FIG. 2 is a high level flowchart illustrating an aspect according to some embodiments of the invention;

FIG. 3 is a high level schematic block diagram illustrating an aspect according to some embodiments of the invention;

FIG. 4 is a high level schematic block diagram illustrating an aspect according to some embodiments of the invention;

FIG. 5 is a high level schematic block diagram illustrating an aspect according to some embodiments of the invention; and

FIG. 6 is a high level flowchart illustrating the method according to some embodiments of the invention.

The drawings together with the following detailed description make apparent to those skilled in the art how the invention may be embodied in practice.

### DETAILED DESCRIPTION

Prior to setting forth the detailed description, it may be helpful to set forth definitions of certain terms that will be used hereinafter.

The term “Open-source software” (OSS) as used herein in this application refers to computer software that is available in source code form: the source code and certain other rights normally reserved for copyright holders are provided under an open software license that permits users to study, change, improve and at times also to distribute the software.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

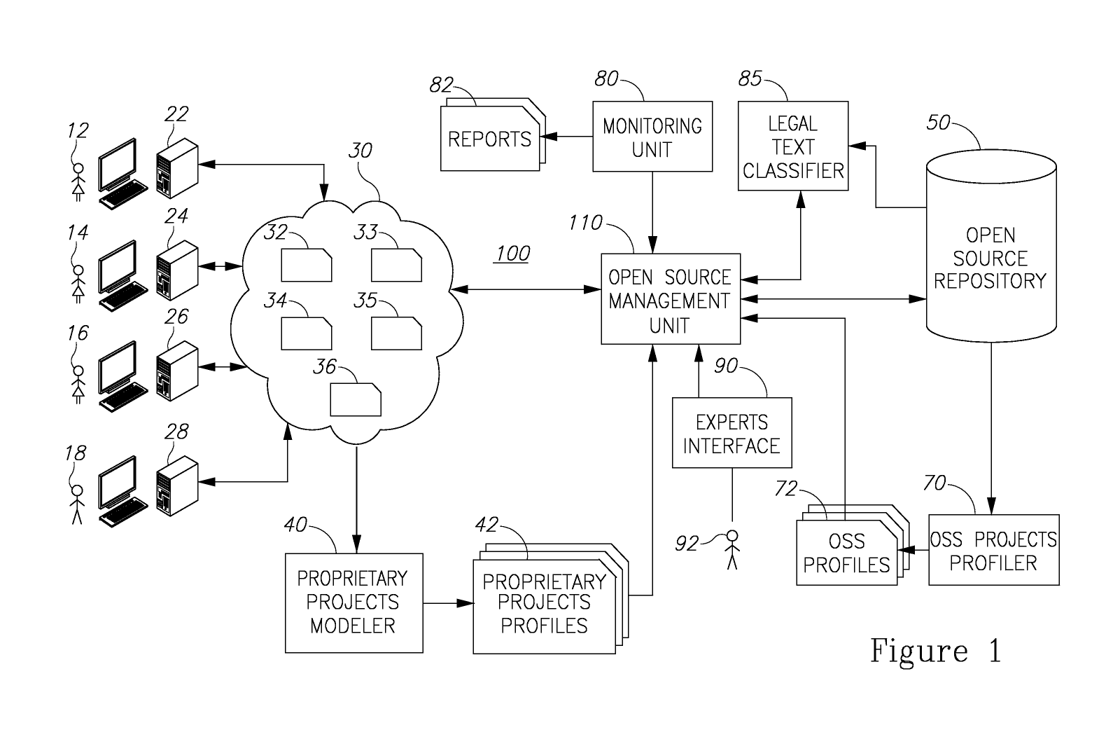

FIG. 1 is a high level schematic block diagram illustrating an environment of a system 100 according to some embodiments of the invention. Proprietary projects environment 30 possibly implemented within a cloud environment according to embodiments of the present invention is shown. A plurality of developer computers 22-28 (such as personal computers) is connected via a computer network (not shown), to projects environment 30. Each one of developers 12-18 is associated with one or more software projects 32-36 on projects environment 30. System 100 further includes an open source repository 50 that is operatively associated with cloud environment 30 and further accessible by developers 12-18 in accordance with the operation of open source management unit 110 as will be further detailed below

In accordance with a first aspect of the present invention system 100 includes proprietary projects modeler 40 operatively associated with projects environment 30. Modeler 40 carries out an in-depth analysis of the product source code of each one of projects 32-36 of developers 12-18 and underlying open source dependencies vis a vis the OSS resources of repository 50. This analysis yields comprehensive proprietary projects profiles 42 possibly in the form of a model indicative of OSS dependencies within projects 32-36. After the complete model is generated it can be used to gain full understanding of the product open source usage and licensing implications. Proprietary projects profiles 42 (the model) may also be used by developers 12-18 to enhance and better utilize OSS resources of repository 50 through exposing risks and alternatives. This analysis may be either run ad hoc or scheduled to run at fixed intervals.

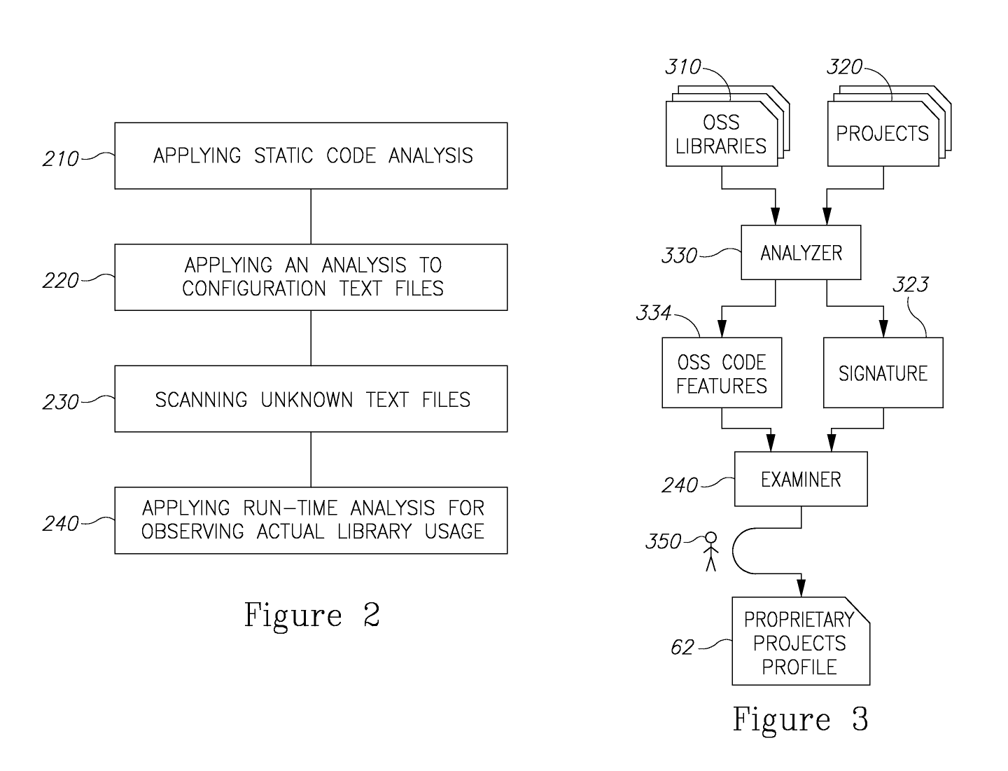

Referring now to FIG. 2, in accordance with some embodiments of the present invention, the analysis may include the following steps: 210 applying a static code analysis to deduce the direct imports of OSS as well as collection of OSS usage information, for example: how it is called, when and what for; 220 applying an analysis to the configuration text files of known frameworks (such as Spring) to deduce indirect imports of OSS that might occur during run-time; 230 scanning of unknown text files in the product to detect references to OSS. These should then be verified by someone from the development team; and 240 conduct run-time analysis of the product, to observe actual library usage in an attempt to detect OSS references that might have been overlooked.

In some embodiments, partial modeling may also be advantageous. For example, a partial modeling may assist, when attempting to validate the list of OSS that the development team declares it either uses it or at least aware of its presence.

Referring now to FIG. 3, in accordance with to some embodiments of the present invention, when scanning the projects code 320 vis a vis OSS libraries 310 by analyzer 330, a special analysis may be carried out in order to extract a set of code features, referred herein as the code signature 323. These features will then be compared by examiner 340 with OSS features 334 of all known OSS that may resemble it. In case of a possible match, the two source code snippets (one sampled from the product and one from the open source repository) will be sent for clerical review by a member 350 of the development team. Various levels of matching may be considered alongside various types of clerical reviews done by the team. At first, these may just be referrals to specific locations in the code, recommending the team to review them. Artificial intelligence methodologies will allow automation of parts of the clerical review as well as improve the results of the matching.

Information collected during proprietary code modeling may include, but are not limited to: references to open source imports; calls made to open source code; usage of open source, usage levels, patterns, and the like; and information about the project (as much as the client allows) such as location, number of development stations, code branches and revisions, and the like.

Referring back to FIG. 1, in accordance with a second aspect of the present invention, system 100 further includes an OSS projects profiler 70 configured to carry out a profiling of the OSS resources of repository 50. The profiling process is achieved by continuously collecting and analyzing information from all relevant open source parties. These parties may include: the development teams, open source providers, clients, legal experts and regulatory professionals. Most of the data will be collected automatically or deduced from behavior observed by the system. These will also include data gathered during code modeling. This automation process will learn various user behaviors and will augment the analysis as more data is collected.

OSS projects profiler 70 may be configured to create and maintain comprehensive OSS profiles 72 of all known OSS. Information about OSS may be organized in indices based on legal status and restrictions, regulatory compliance levels, code quality and security vulnerability alongside other indicators.

Consequently, system 100, using open source management unit 110 may rank OSS resources for specific situations. For example, whenever one of developers 12-18 wishes to consider OSS alternatives to a given task, open source management unit 110 may be able to present a detailed suggestion of various OSS and rank them according to their profile, relevance to the team and the specific projects or products the team members are on.

Consistent with some embodiments of the present invention, a monitoring unit 80 is further provided. Monitoring unit 80 may be configured to generate ad hoc reports 82 presenting these ranks, either for a specific context or as a general index. Advantageously, this feature enables open source management unit 110 to present public global indices of OSS that may be consumed by various on-line forums.

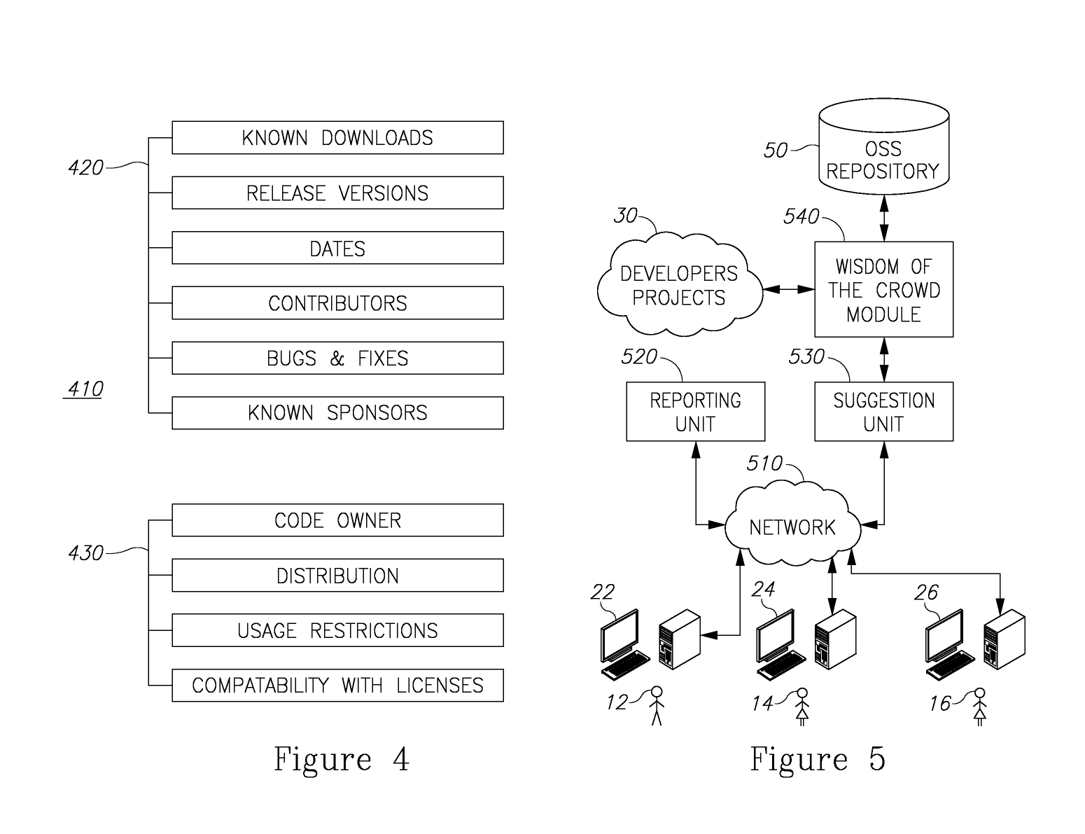

Referring now to FIG. 4, in order to implement OSS projects profiler 70, predefined profile technical attributes may be used. An exemplary non-limiting list of OSS profile technical attributes 420 may include the following: known downloads and download mirrors; release versions (plus durations between them and changes in these durations); revisions (plus durations and changes); dates of last release, version and revision; contributors (numbers, distributions, affiliations); bugs and fixes (durations and trends); and known sponsors. Similarly, some predefined profile legal attributes may be used. An exemplary non-limiting list of OSS profile legal attributes 430 may include the following: code owner; distribution (whether or not it can it be redistributed. if so, under what conditions); usage restrictions (either local usage or distributed usage); and compatibility with known licenses.

Consistent with some embodiments of the present invention, when collecting information on OSS projects and the developers teams using it, statistics will be calculated and community-based insight can be generated. Reports may include information by geographic location, legal restrictions, usage patterns and more.

Consistent with some embodiments of the present invention, a dedicated graphical user interface (GUI) may be provided. The dedicated GUI may be configured to provide a schematic visualization of on-going profiling and data maintenance throughout the software developing process. For example, which OSS resources are being used, their risks, updates, usage history and the like.

Referring back to FIG. 1 in accordance with a third aspect of the present invention, open source management unit 110 may be configured to, via monitoring unit 80, automatically track and monitor of OSS changes, updates and security vulnerabilities. In some embodiments, open source management unit 110 may be operatively associated with a notifying unit (not shown) configured to regularly send alerts to development teams of developers 12-18 about the OSS resources they use. These alerts will be generated, for example, whenever a license or terms of license of an OSS resource change; Alternatively, when a new security vulnerability was detected in an OSS resource or whenever a new version of a OSS library was released or upon a release of a better OSS library (in terms of license or maturity or usage statistics) that might be an alternative to the one in use.

Referring now to FIG. 5, consistent with some embodiments of the present invention, open source management unit 110 may be further operatively associated with a suggestion unit 530. Suggestion unit 530 is configured to carry out two services as follows. The first will assist developers 12-18 to select the right project for their task for the first time. The second will suggest possible alternatives to an OSS resource already in use. These suggestions will be based on the project ranks as well as on developers 12-18 and product's profile and may be implemented by a wisdom of the crown module 540 that monitors both cloud of proprietary projects 30 and OSS repository 50. Suggestion unit 530 may be configured to provide developers 12-18 with insights and suggestions, based on pre-calculated OSS profiles 72, and teams as well as statistics gathered and knowledge extracted. For any specific team, the suggestions may include: an identification of OSS library upgrades or replacement in teams whose profiles are similar to the one used; OSS that are used often by similar teams; functions within these OSS that are popular and not used by a specific developer; an OSS similar to those a specific developer is using but have different license terms. Suggestion engine may also detect when similar teams are migrating to these projects and also OSS that were used but other teams for a short period and then abandoned (this attribute will also be used for OSS profiling). All of the generated insight and suggestions, along with the straight-forward data collected and community generated knowledge, may be consumed in various methods (by various consumers). Exemplary and non-limiting forms of insights and suggestions may include: alerts (as mentioned above); OSS smart-search. This service will let users search OSS by all the common criteria as well as by matching OSS profiles to a team's profile, and leveraging insight and community information. The search may include active suggestions, based on all the internal intelligence. Advantageously, the suggestions engine may be further operatively associated with a virtual marketplace of OSS, featuring tailored recommendations as well as global community ranking and profile-based ranking.

Referring back to FIG. 1, consistent with some embodiments of the present invention, open source management unit 110 may be further operatively associated with an experts interface 90 configured to facilitate external professional services 92 to the team. There are two types of external services. First are legal opinion services that match the needs of developers 12-18. Profiles of the team as well as the service provider will be taken into account. The profiles may include geography, compliance requirements, and the like. The second type is OSS-specific professional services. This will match service providers that specialize in a specific OSS to the teams which use it.

According to a forth aspect of the present invention, there is provided a license text contextual analysis feature. System 100 may further include a legal text classifier 85 configured to carry out a contextual analysis of any arbitrary license text. Legal text classifier 85 may be further operatively associated with an active repository of license attributes (not shown). For example, each individual restriction associated with a license will be considered as an attribute of the license. When a new license text is introduced into system 100, it will be analyzed and broken-down into its attributes. Legal text classifier 85 will then be able to provide any part of several services, including but not limited to, listing important attributes in human readable language, indicate a known license that is “close” (in legal terms) to the given license, and highlight important (risky) parts of the license text.

Legal text classifier 85 may apply a semantic classification function that compares the legal attributes of a newly added license with a repository of predefined and pre-analyzed known licenses. Legal text classifier 85 may computer the so-called distance between the newly added licenses from known licenses in the legal attributes space and indicate the closest license or licenses. Thus the developer may know which known license resembles the newly added one.

As these services are provided to developers 12-18, their responses will be tracked and the system will learn from actual usage to improve the database and add more information on each license attributes, as well as new types of attributes.

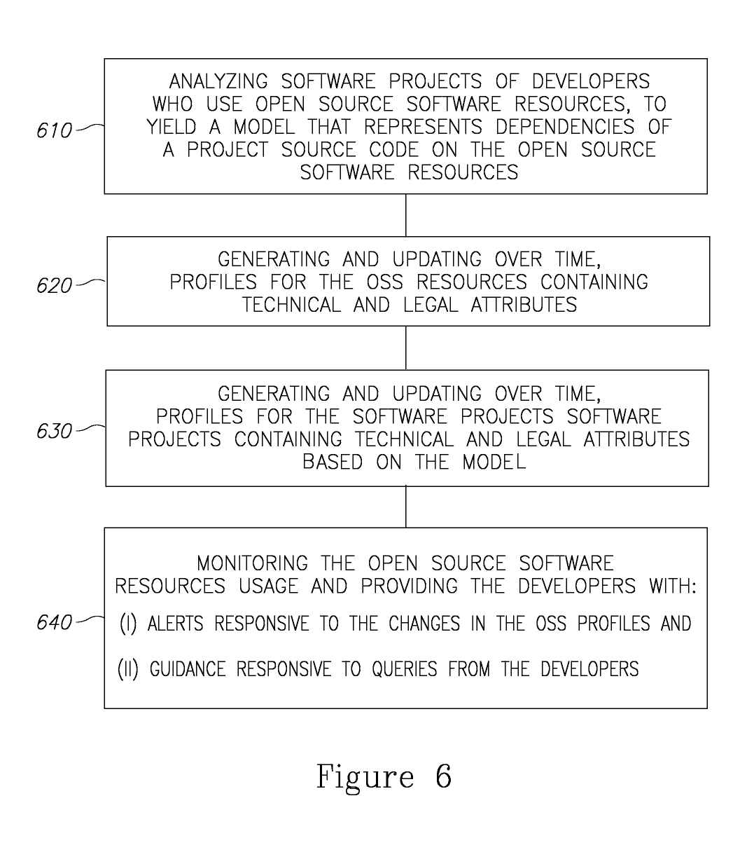

FIG. 6 is a high level flowchart diagram illustrating a method according to some embodiments of the invention. Method 600 is not limited to the aforementioned architecture of system 100. Method 600 starts with analyzing the software projects, to yield proprietary projects model that represents dependencies of source code portions of the software projects upon the OSS resources 610; generating and updating over time, OSS profiles for the OSS resources exhibiting technical and legal attributes thereof 620; generating and updating over time, projects profiles for the software projects, based on the model 630; and monitoring actual OSS resources usage and providing the developers with at least one of: (i) reports responsive to the changes the OSS; and (ii) guidance responsive to queries from the developers, wherein the reports and the guidance are based on the actual OSS usage, projects model, the projects profiles, and the OSS profiles 640.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The aforementioned flowchart and diagrams illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

What is claimed is:

1. A system for controlling and managing open source software (OSS) resources provided by OSS providers and used by developers in their proprietary software projects, the system comprising:
a proprietary projects modeler configured to analyze the proprietary software projects, to yield a proprietary projects profiles that represent dependencies of source code portions of the software projects upon the OSS resources;
an OSS profiler configured to generate and update over time, OSS profiles for the OSS resources exhibiting technical and legal attributes thereof;
a proprietary projects profiler configured to generate and update over time, projects profiles for the software projects, based on the proprietary projects model; and
a open source management unit configured to monitor actual OSS resources usage and provide the developers with at least one of: (i) reports responsive to the changes the OSS; and (ii) guidance responsive to queries from the developers, wherein the reports and the guidance are based on the actual OSS usage, projects model, the projects profiles, and the OSS profiles.

2. The system according to claim 1, wherein the modeler is configured to generate the proprietary projects model by carrying out at least one of the following steps: (i) applying a static code analysis to deduce direct imports of OSS as well as collection of OSS usage information; (ii) applying an analysis to configuration text files of known frameworks, to deduce indirect imports of OSS that potentially occur during run-time; (iii) scanning of unknown text files in the project to detect references to OSS; and (iv) conducting run-time analysis of the project, to observe actual library usage in an attempt to detect overlooked OSS references.

3. The system according to claim 1, wherein the technical attributes of the OSS profile comprise at least one of: known downloads and download mirrors; release versions; revisions; dates of last release, version and revision; contributors; bugs and fixes; and known sponsors.

4. The system according to claim 1, wherein the legal attributes of the OSS profile comprise at least one of: code owner; distribution; usage restrictions; and
compatibility with known licenses.

5. The system according to claim 1, further comprising a dedicated graphical user interface configured to provide a schematic visualization of on-going profiling and data maintenance throughout the software developing process.

6. The system according to claim 1, further comprising a suggestion unit configured to: (i) assist the developers to select the right project for their task for the first time; and (ii) suggest possible alternatives to an OSS already in use, wherein the suggestions are based on crowd sourcing carried by a wisdom of the crowd module and based on project ranks given by developers and respective projects profiles and OSS profiles.

7. The system according to claim 6, the suggestions comprise at least one of: an identification of library upgrades or replacement in teams whose profiles are similar to the one used; an OSS that are used often by similar teams; functions within these OSS that are popular and not used by a specific developer; and an OSS similar to those a specific developer is using but have different license terms.

8. The system according to claim 1, further comprising an expert interface configured to facilitate external professional services to the developers, wherein the professional services comprise: legal opinion services that match need of the developers needs; and other professional services of service providers that specialize in a specific OSS to the teams which use it.

9. The system according to claim 1, further comprising a legal text classifier configured to analyze any existing and added open source software on the repository and provide the developers with insights and caveats in regards with open source software portions applicable to their projects.

10. The system according to claim 1, further comprising a legal text classifier configured to apply a classifier to licenses of to OSS resources to indicate proximity of the license to known OSS licenses, by computing a distance in a legal attributes spaces, wherein the legal attributes are predefined so as to indicate legal risks in using the OSS resources.

11. A method of controlling and managing open source software (OSS) resources provided by OSS providers and used by developers in their software projects, the system comprising:
analyzing the software projects, to yield a proprietary projects model that represents dependencies of source code portions of the software projects upon the OSS resources;
generating and updating over time, OSS profiles for the OSS resources exhibiting technical and legal attributes thereof;
generating and updating over time, projects profiles for the software projects, based on the proprietary projects model; and
monitoring actual OSS resources usage and provide the developers with at least one of: (i) reports responsive to the changes the OSS; and (ii) guidance responsive to queries from the developers, wherein the reports and the guidance are based on the actual OSS usage, projects model, the projects profiles, and the OSS profiles.

12. The method according to claim 11, wherein the analyzing further comprises at least one of: (i) applying a static code analysis to deduce direct imports of OSS as well as collection of OSS usage information; (ii) applying an analysis to configuration text files of known frameworks, to deduce indirect imports of OSS that potentially occur during run-time; (iii) scanning of unknown text files in the project to detect references to OSS; and (iv) conducting run-time analysis of the project, to observe actual library usage in an attempt to detect overlooked OSS references.

13. The method according to claim 11, wherein the technical attributes of the OSS profile comprise at least one of: known downloads and download minors; release versions; revisions; dates of last release, version and revision; contributors; bugs and fixes; and known sponsors.

14. The method according to claim 11, wherein the legal attributes of the OSS profile comprise at least one of: code owner; distribution; usage restrictions; and
compatibility with known licenses.

15. The method according to claim 11, further comprising providing a schematic visualization of on-going profiling and data maintenance throughout the software developing process.

16. The method according to claim 11, further comprising providing suggestions configured to: (i) assist the developers to select the right project for their task for the first time; and (ii) suggest possible alternatives to an OSS already in use, wherein the suggestions are based on crowd sourcing carried by a wisdom of the crowd module and based on project ranks given by developers and respective projects profiles and OSS profiles.

17. The method according to claim 16, wherein the suggestions comprise at least one of: an identification of library upgrades or replacement in teams whose profiles are similar to the one used; an OSS that are used often by similar teams; functions within these OSS that are popular and not used by a specific developer; and an OSS similar to those a specific developer is using but have different license terms.

18. The method according to claim 11, further comprising providing an expert interface configured to facilitate external professional services to the developers, wherein the professional services comprise: legal opinion services that match need of the developers needs; and other professional services of service providers that specialize in a specific OSS to the teams which use it.

19. The method according to claim 11, further comprising analyzing any existing and added open source software on the repository and providing the developers with insights and caveats in regards with open source software portions applicable to their projects.

20. A computer program product for controlling and managing open source software (OSS) resources provided by OSS providers and used by developers in their software projects, the computer program product comprising:
a non-transitory computer readable medium having computer readable program embodied therewith, the computer readable program comprising:
computer readable program configured to analyze the software projects, to yield a proprietary projects model that represents dependencies of source code portions of the software projects upon the OSS resources;
computer readable program configured to generate and update over time, OSS profiles for the OSS resources exhibiting technical and legal attributes thereof;
computer readable program configured to generate and update over time, projects profiles for the software projects, based on the proprietary model; and
computer readable program configured to monitor actual OSS resources usage and provide the developers with at least one of: (i) reports responsive to the changes the OSS; and (ii) guidance responsive to queries from the developers, wherein the reports and the guidance are based on the actual OSS usage, projects model, the projects profiles, and the OSS profiles.
